(19) United States
(12) Patent Application Publication
(10) Pub. No.: US 2016/0039368 A1
(43) Pub. Date: Feb. 11, 2016

(54) GROMMET

(71) Applicant: SUMITOMO WIRING SYSTEMS, LTD., Mie (JP)

(72) Inventors: Masaru SHITAMICHI, Mie (JP); Yoshinao KOBAYASHI, Mie (JP)

(73) Assignee: SUMITOMO WIRING SYSTEMS, LTD., Mie (JP)

(21) Appl. No.: 14/782,839

(22) PCT Filed: Apr. 7, 2014
(86) PCT No.: PCT/JP2014/060048

§ 371 Date: Oct. 7, 2015

(30) Foreign Application Priority Data
Apr. 22, 2013 (JP) 2013-089310

(51) Int. Cl. B60R 16/02; F16L 5/02

(52) U.S. Cl. CPC B60R 16/0222; F16L 5/02

(57) ABSTRACT

A grommet that can achieve both an improvement of visibility of a locking portion at the start of attachment of the grommet and a reduction of an insertion force that is required during the attaching operation, and that thus has excellent ease of attachment is provided. A grommet includes a truncated cone-shaped portion having a larger diameter than an attachment hole, an annular seal lip portion on an attachment surface side that opposes a panel member, a first locking portion that protrudes from the attachment surface on an inward side with respect to a radial direction of the annular seal lip portion, and that is to be locked on the panel member, and a second locking portion that protrudes from the attachment surface on the inward side with respect to the radial direction of the annular seal lip portion, and that is to be locked on the panel member.

### TECHNICAL FIELD

The present invention relates to a grommet and particularly relates to a grommet that, when mounted onto an attachment hole that is formed in a panel member such as a vehicle body panel or the like, protects a wire harness and the like inserted into that attachment hole and seals the attachment hole in a water-tight manner.

### BACKGROUND ART

Generally, a panel member such as a vehicle body panel or the like has a plurality of openings into which wiring and piping are inserted. An opening into which a wire harness or the like is inserted constitutes an attachment hole to which a grommet for protecting the wire harness and for waterproofing is attached.

As a conventional grommet of this type, as shown in FIG. 5, for example, a grommet is known in which a coupling flange 112 of an insertion tube portion 104 into which a wire harness (wire group) W is inserted is fitted into a space behind a waterproof lip 106 of a grommet main portion 102, and a seal ring 118 is placed in the vicinity of a front locking claw 105A and a rear locking claw 105B on a leading end side of the insertion tube portion 104 (see Patent Document 1, for example).

With this grommet, in a state in which the front locking claw 105A is engaged with a back surface side of a through hole 108, a coupling portion 113 of the grommet main portion 102 is pushed toward the through hole 108, thereby engaging the rear locking claw 105B with an outer circumferential portion of the through hole 108. This is advantageous in that the operation for attaching the grommet can be facilitated when compared with the case where the grommet is fitted linearly into the through hole 108 by pushing the grommet main portion 102 and the insertion tube portion 104 into the through hole 108 while aligning the center of the insertion tube portion 104 with the center of the through hole 108.

### CITATION LIST

### Patent Documents

Patent Document 1: JP H08-007688A

### SUMMARY OF INVENTION

### Technical Problem

However, in the above-described conventional grommet, the front locking claw 105A and the rear locking claw 105B are provided radially inward of the waterproof lip 106, and furthermore, a circumferential end surface of the coupling portion 113 is disposed radially outward of the waterproof lip 106 and on a side that is closer to a worker. Therefore, during the operation for attaching the grommet, the front locking claw 105A, the seal ring 118, and the like are hardly visible, and thus the operation for attaching the grommet cannot be sufficiently facilitated.

To address this issue, it is possible to improve the visibility of the vicinity of the through hole 108 by reducing the diameters of the coupling flange 112 of the insertion tube portion 104 and the coupling portion 113 of the grommet main portion 102. However, in that case, the more the visibility of the front locking claw 105A and the like is increased by reducing the diameter of the coupling portion 113 of the grommet main portion 102, the larger the force that is required to push the coupling portion 113 toward the through hole 108, that is, an insertion force that is required to attach the grommet. For this reason, the operation for attaching the grommet still cannot be sufficiently facilitated.

Thus, it is an object of the present invention to provide a grommet that can achieve both an improvement of the visibility of a locking portion at the start of attachment of the grommet and a reduction of the insertion force that is required during the attaching operation, and that thus has excellent ease of attachment.

### Solution to Problem

To achieve the above-described object, a grommet according to the present invention is a grommet including a tubular grommet main body that has a truncated cone-shaped portion having a larger diameter than an attachment hole of a panel member and that has an annular seal lip portion on an attachment surface side of the truncated cone-shaped portion that opposes the panel member, a first locking portion that protrudes from the attachment surface of the truncated cone-shaped portion on an inward side with respect to a radial direction of the annular seal lip portion, and that is to be locked on the panel member through the attachment hole, and a second locking portion that protrudes from the attachment surface of the truncated cone-shaped portion on the inward side with respect to the radial direction of the annular seal lip portion, and that is to be locked on the panel member through the attachment hole when the annular seal lip portion of the grommet main body comes into contact with the panel member. The grommet is configured such that the first locking portion has a base end portion that protrudes from the attachment surface of the grommet main body on the inward side with respect to the radial direction of the annular seal lip portion, and a leading end portion that protrudes from the base end portion toward the truncated cone-shaped portion on an outward side with respect to the radial direction of the annular seal lip portion, and the second locking portion is disposed on a side that is opposite to the first locking portion with respect to at least the center of the truncated cone-shaped portion of the grommet main body.

With this configuration, the leading end portion of the first locking portion of the grommet according to the present invention is located on the outward side with respect to the radial direction of the annular seal lip portion, and thus the visibility of the first locking portion at the start of attachment of the grommet can be improved. Moreover, it is possible that during attachment of the grommet according to the present invention to the panel member, the first locking portion is inserted into the attachment hole first, the grommet is rotated using that first locking portion as the fulcrum, and the second locking portion that is disposed on the side opposite to the first locking portion is locked on the panel member. As a result, a long distance between the leading end portion of the first locking portion, which serves as the fulcrum, and the second locking portion, which serves as the point of application of force, can be secured, because the leading end portion of the first locking portion is located on the outward side with respect to the radial direction of the annular seal lip portion. Thus, the grommet can be easily inserted into the attachment hole using the principle of levers. Accordingly, the insertion force that is required during the attaching operation can be reduced.

Therefore, the grommet according to the present invention can provide a grommet that can achieve both an improvement of the visibility of the locking portion at the start of attachment of the grommet and a reduction of the insertion force that is required during the attaching operation, and that thus has excellent ease of attachment.

Moreover, in the grommet having the above-described configuration, the grommet main body may have a tubular insertion wail portion that is to be inserted into the attachment hole of the panel member, and the first locking portion and the second locking portion may be formed integrally with the insertion wall portion.

With this configuration, in the grommet according to the present invention, the first locking portion and the second locking portion can be formed integrally with the insertion wall portion, so that the strength of the grommet can be secured while reducing the manufacturing cost of the grommet.

Moreover, in the grommet having the above-described configuration, the insertion wall portion may be composed of a hard material having a flange portion that is embedded in the truncated cone-shaped portion, and at least the annular seal lip portion may be composed of an elastic material that is softer than the hard material.

With this configuration, in the grommet according to the present invention, the first locking portion, the second locking portion, and the like, which are integral with the insertion wall portion, and the flange portion can be composed of a hard material. Moreover, when the grommet is mounted onto the attachment hole, and the annular seal lip portion abuts against the panel member on the outside of the attachment hole, the seal lip portion composed of an elastic material that is softer than the insertion wall portion can be supported by the flange portion, and thus the sealability can be secured.

### Advantageous Effects of Invention

According to the present invention, it is possible to provide a grommet that can achieve both the improvement of the visibility of a locking portion at the start of attachment of the grommet and the reduction of the insertion force that is required during the attaching operation, and that thus has excellent ease of attachment.

### BRIEF DESCRIPTION OF DRAWINGS

FIG. 1 is a cross-sectional view showing a state in which a grommet according to a first embodiment of the present invention is fitted to a panel member.

FIG. 2 is a cross-sectional view showing a state before the grommet according to the first embodiment of the present invention is fitted to the panel member.

FIG. 3 is a perspective view showing the state in which the grommet according to the first embodiment of the present invention is fitted to the panel member.

FIG. 4 is a cross-sectional view showing a state in which the grommet according to the present embodiment is fitted to another panel member.

FIG. 5 is a cross-sectional view showing a conventional grommet.

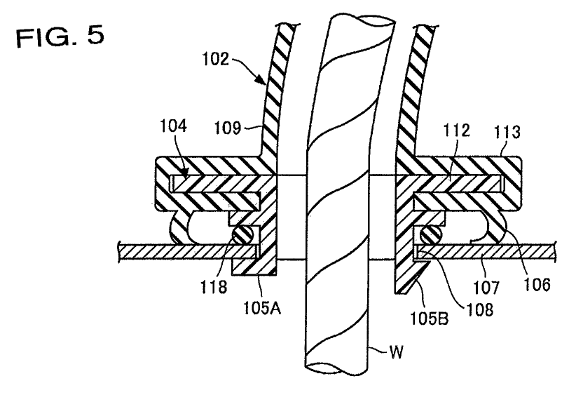

### DESCRIPTION OF EMBODIMENTS

Next, an embodiment of the present invention will be described with reference to the drawings.

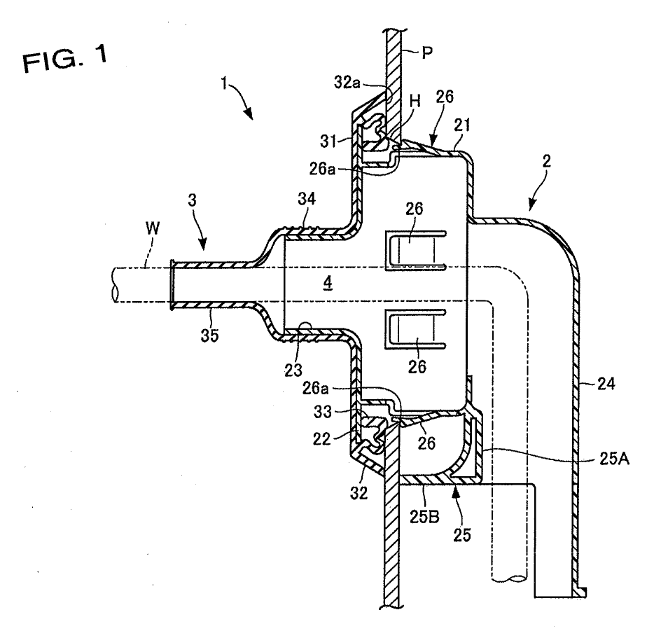

The configuration will be described first. FIGS. 1 to 3 show a grommet according to the present embodiment.

As shown in FIGS. 1 to 3, a grommet 1 is constituted by a wire group insertion member 2 that is composed of a hard material such as polypropylene, for example, and a seal member 3 that is composed of an elastic material that is softer than the wire group insertion member 2, such as synthetic rubber (silicone rubber) or an elastomer for example. The grommet 1 is attached to an attachment hole H of a panel member P.

The panel member P may be a vehicle body panel or the like and has the attachment hole H into which a wire group W is inserted via the grommet 1. The attachment hole H is a through hole that is formed in the panel member P and that has a perfect circular shape, an elliptical or oval shape, or a rectangular shape. Preferably, the attachment hole H is a through hole having an elliptical or oval shape or a rectangular shape that is elongated in the vertical direction in FIG. 1. The attachment hole H is configured such that attaching the grommet 1 between the wire group W and the attachment hole H secures a tight enough seal to prevent intrusion of foreign matter such as water.

The wire group insertion member 2 has an insertion wall portion 21, a flange portion 22, a first insertion portion 23, a second insertion portion 24, a first locking portion 25, and second locking portions 26, the various portions being integrated into a single body.

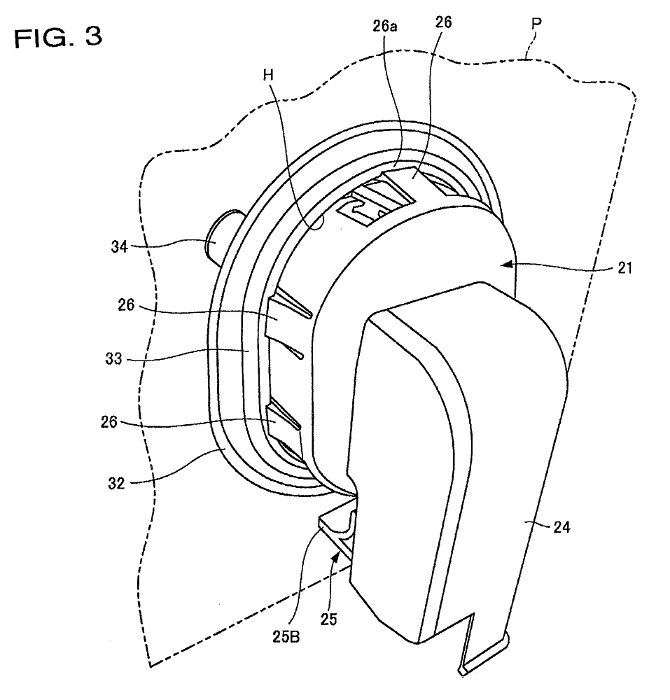

In the present embodiment, as shown in FIG. 3, the insertion wall portion 21 is formed into a tubular shape having substantially the same shape as the opening edge shape of the attachment hole H that has a substantially elliptical shape. Moreover, the insertion wall portion 21 is configured to be located on an inner circumference of the attachment hole H when the grommet 1 is attached to the panel member P.

The flange portion 22 is disposed between the first insertion portion 23 and the insertion wall portion 21 in such a manner as to be embedded in a truncated cone-shaped portion 32, which will be described later. The flange portion 22 has an increased diameter such that its outer circumferential edge is located radially outward of the attachment hole H, and is configured to oppose the panel member P when the grommet 1 is attached to the panel member P.

The first insertion portion 23 is disposed radially inward of the flange portion 22 and closer to the seal member than the insertion wall portion 21 is. The first insertion portion 23 is configured to have a substantially cylindrical shape, and the wire group W from the inside of the seal member 3 is directly inserted into the first insertion portion 23.

The second insertion portion 24 is disposed on a side of the insertion wall portion 21 that is opposite to the first insertion portion 23, and has a tubular shape that is bent so as to extend parallel to the panel member P. Thus, the wire group W from the insertion wall portion 21 is inserted into the second insertion portion 24 in a bent state.

The first locking portion 25 has a base end portion 25A and a leading end portion 25B that are integrated into a single body. The base end portion 25A shares the insertion wall portion 21 in a lower portion of the drawings and therefore protrudes from an attachment surface 32a on an inward side with respect to a radial direction of an annular seal lip portion 33, which will be described later. In addition to sharing the insertion wall portion 21, the base end portion 25A extends parallel to the panel member P and outwardly with respect to the radial direction of the annular seal lip portion 33. The leading end portion 25B protrudes from an end of the base end portion 25A toward the truncated cone-shaped portion 32, on an outward side with respect to the radial direction of the annular seal lip portion 33.

The second locking portions 26 are formed at a plurality of positions on the insertion wall portion 21. The second locking portions 26 protrude from the attachment surface 32a on the inward side with respect to the radial direction of the annular seal lip portion 33, and are locked on the panel member P through the attachment hole H when the annular seal lip portion 33 comes into contact with the panel member P. One of the second locking portions 26, that is, the second locking portion 26 in an upper portion of the drawings is disposed on a side opposite to the first locking portion 25 with respect to the center of the truncated cone-shaped portion 32.

Each of the second locking portions 26 is formed by separating a portion of the insertion wall portion 21 from the insertion wall portion 21, with one end of that portion being left connected to the insertion wall portion 21, in such a manner as to be cut and raised from the insertion wall portion 21. An engagement claw 26a is formed at the other end of the second locking portion 26, and the other end can be displaced toward the inside of the insertion wall portion 21. Accordingly, when the grommet 1 is mounted onto the panel member P, the second locking portion 26 is pressed against an opening edge portion of the attachment hole H and temporarily displaced to the inside of the insertion wall portion 21. In a state in which the grommet 1 is attached to the panel member P, the other end of the second locking portion 26 is out of the attachment hole H and is elastically restored, and the locking claw 26a at the one end is locked on the opening edge portion of the attachment hole H.

The seal member 3 is the member for securing the sealability between the wire group insertion member 2 and the panel member P. The seal member 3 has a flange covering portion 31, the truncated cone-shaped portion 32, the annular seal lip portion 33, a wire group insertion port covering portion 34, and a wire group sealing portion 35.

The flange covering portion 31 covers the flange portion 22 such that the flange portion 22 is embedded therein. Moreover, the annular seal lip portion 33 is formed integrally with the flange covering portion 31 on a side of the flange covering portion 31 that opposes the panel member P.

The annular seal lip portion 33 is formed into a pleated shape, protruding annularly from the truncated cone-shaped portion 32 and the flange covering portion 31 so as to oppose the panel member P, and secures the sealability of the outer circumference of the attachment hole H by being pressed against the panel member P. The annular seal lip portion 33 is configured such that the pressing force applied to the panel member P is not dissipated, because the flange portion 22 made of a hard material is located between the annular seal lip portion 33 and the flange covering portion 31.

The wire group insertion port covering portion 34 is formed into a cylindrical shape that is continuous with the flange covering portion 31 and covers the first insertion portion 23.

The wire group sealing portion 35 is a cylindrical tube member that is formed continuously with the wire group insertion port covering portion 34, and secures the sealability by covering the wire group W. The wire group sealing portion 35 has a smaller diameter than the wire group insertion port covering portion 34 and covers the wire group W while being in close contact therewith.

The truncated cone-shaped portion 32 is formed by covering the flange portion 22 with the flange covering portion 31, and is configured to have a larger diameter than the attachment hole H of the panel member P.

The wire group insertion port covering portion 34 and the wire group sealing portion 35 are tubular members and have a communication hole 4 inside, into which the wire group W is inserted. Moreover, the grommet 1 has the insertion wall portion 21 that is inserted into the attachment hole H of the panel member P, and the first locking portion 25 and the second locking portions 26 are formed integrally with the insertion wall portion 21.

It should be noted that the truncated cone-shaped portion 32 having a larger diameter than the attachment hole H of the panel member P, the annular seal lip portion 33 provided on the attachment surface 32a side of the truncated cone-shaped portion 32 that opposes the panel member P, and the tubular insertion wall portion 21 that is to be inserted into the attachment hole H of the panel member P constitute a tubular grommet main body according to the present invention.

Next, a method for mounting the grommet 1 according to the present embodiment onto the panel member P will be described.

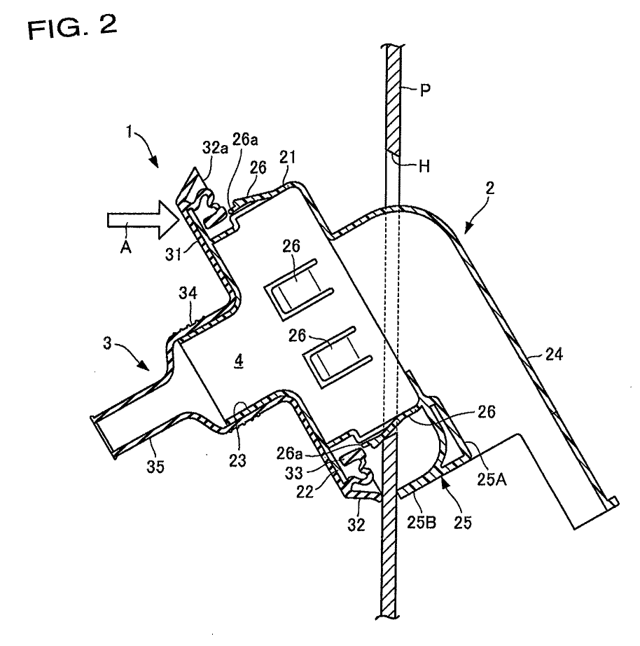

First, as shown in FIG. 2, during mounting of the grommet 1, the first locking portion 25 is inserted from the attachment hole H of the panel member P and positioned such that a lower portion of the attachment hole H of the panel member P in the drawings is sandwiched between the leading end portion 25B and the truncated cone-shaped portion 32.

Next, when the grommet 1 is pushed into the attachment hole H using the point of application of force that is indicated by arrow A in FIG. 2, the insertion wall portion 21 is rotated about the point of abutment between the leading end portion 25B of the first locking portion 25 and the panel member P, the point of abutment serving as the fulcrum, and is fitted into the attachment hole H.

Then, when the grommet 1 continues to be pushed into the attachment hole H, as shown in FIG. 1, the locking claw 26a on the opposite side to the first locking portion 25 is locked on the opening edge portion of the attachment hole H, and the grommet 1 is fitted into the attachment hole H.

As described above, according to the present embodiment, in the grommet 1, the leading end portion 25B of the first locking portion 25 is located on the outward side with respect to the radial direction of the annular seal lip portion 33, and thus the visibility of the first locking portion 25 at the start of attachment of the grommet 1 can be improved. Moreover, during attachment of the grommet 1 to the panel member P, the first locking portion 25 is first inserted into the attachment hole H, the grommet 1 is rotated using the point of abutment between the leading end portion 25B of that first locking portion 25 and the panel member P as the fulcrum of rotation, and the second locking portion 26 disposed on the opposite side to the first locking portion 25 is locked on the panel member P. The grommet 1 can be attached to the panel member P in this manner.

More specifically, the insertion wall portion 21 is fitted into the attachment hole H from the lower end of the insertion wall portion 21 in the drawings, and then upper portions of the insertion wall portion 21 in the drawings are gradually fitted into the attachment hole H. At this time, in the present embodiment, the portion that is located radially outward of the annular seal lip portion 33, that is, the region of abutment between the leading end portion 25B of the first locking portion 25 and the panel member P is used as the fulcrum of rotation of the grommet 1. Therefore, the point of application of force, which is indicated by arrow A in FIG. 2, can be set at a position that is farthest from the fulcrum of rotation. Thus, according to the principle of levers, only a small pushing force is required to be exerted on the point of application of force.

Thus, both an improvement of the visibility of the first locking portion 25 and the second locking portions 26 at the start of attachment of the grommet 1 and a reduction of an insertion force that is required during the attaching operation can be achieved, so that excellent ease of attachment can be achieved.

Moreover, when compared with a pushing force that is required in the case where a grommet having a configuration equivalent to that of a conventional grommet is prepared by removing the first locking portion 25 and attached linearly to the attachment hole, the grommet 1 of the present embodiment can be fitted into the attachment hole H by 15 to 20% of that pushing force.

Moreover, since the first locking portion 25 and the second locking portions 26 are formed integrally with the insertion wall portion 21, the manufacturing cost of the grommet 1 can be reduced. Also, the strength of the grommet 1 can be increased.

Moreover, the first locking portion 25, the second locking portions 26, and the like, which are integral with the insertion wall portion 21, and the flange portion 22 can be composed of a hard material. Moreover, when the grommet 1 is mounted onto the attachment hole H, and the annular seal lip portion 33 abuts against the panel member P on the outside of the attachment hole H, the annular seal lip portion 33 composed of an elastic material that is softer than the insertion wall portion 21 can be supported by the flange portion 22, and thus the sealability can be secured.

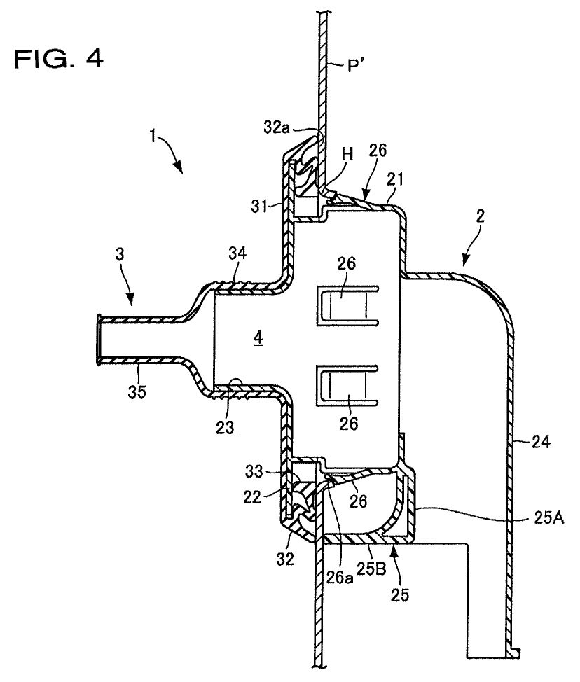

Incidentally, although the attachment hole H of the panel member P of the foregoing embodiment is shown as a simple opening that is formed by for example, punching or the like of a sheet metal, as shown in FIG. 4, for example, the present invention is also applicable to a panel member P′ in which the opening circumferential edge portion of the attachment hole H is bent so as to have a certain thickness.

As described above, a grommet according to the present invention has the effect of being capable of providing a grommet that can achieve both an improvement of the visibility of a locking portion at the start of attachment of that grommet and a reduction of the insertion force that is required during the attaching operation, and that thus has excellent ease of attachment, and is useful for all grommets including a grommet that, when mounted onto an attachment hole that is formed in a vehicle body panel, protects a wire harness or the like inserted into the attachment hole and seals the attachment hole in a water-tight manner, such as a grommet for a wire harness that is routed in an environment in which its path meanders, for example.

### LIST OF REFERENCE NUMERALS

P Panel member

H Attachment hole

21 Insertion wall portion

22 Flange portion

25 First locking portion

25A Base end portion

25B Leading end portion

26 Second locking portion

32 Truncated cone-shaped portion

32a Attachment surface

33 Annular seal lip portion

1. A grommet comprising:
a tubular grommet main body that has a truncated cone-shaped portion having a larger diameter than an attachment hole of a panel member and that has an annular seal lip portion on an attachment surface side of the truncated cone-shaped portion that opposes the panel member;
a first locking portion that protrudes from the attachment surface of the truncated cone-shaped portion on an inward side with respect to a radial direction of the annular seal lip portion, and that is configured to be locked on the panel member through the attachment hole; and
a second locking portion that protrudes from the attachment surface of the truncated cone-shaped portion on the inward side with respect to the radial direction of the annular seal lip portion, and that is configured to be locked on the panel member through the attachment hole when the annular seal lip portion comes into contact with the panel member,
wherein the first locking portion has a base end portion that protrudes from the attachment surface of the truncated cone-shaped portion on the inward side with respect to the radial direction of the annular seal lip portion, and a leading end portion that protrudes from the base end portion toward the truncated cone-shaped portion on an outward side with respect to the radial direction of the annular seal lip portion, and
the second locking portion is disposed on a side that is opposite to the first locking portion with respect to at least the center of the truncated cone-shaped portion.

2. The grommet according to claim 1,
wherein the grommet main body has a tubular insertion wall portion that is configured to be inserted into the attachment hole of the panel member, and the first locking portion and the second locking portion are formed integrally with the insertion wall portion.

3. The grommet according to claim 2,
wherein the insertion wall portion is composed of a hard material having a flange portion that is embedded in the truncated cone-shaped portion, and
at least the annular seal lip portion is composed of an elastic material that is softer than the hard material.
